(19) United States
(12) Patent Application Publication
(10) Pub. No.: US 2016/0196189 A1
(43) Pub. Date: Jul. 7, 2016

(54) FAILURE MONITORING DEVICE, COMPUTER-READABLE RECORDING MEDIUM, AND FAILURE MONITORING METHOD

(71) Applicant: FUJITSU LIMITED, Kawasaki-shi (JP)

(72) Inventors: Koyo Miyagi, Ota (JP); Hideki Sakurai, Kawasaki (JP); Yusuke Hayashi, Kawasaki (JP); Masayuki Wakita, Yokohama (JP)

(73) Assignee: FUJITSU LIMITED, Kawasaki-shi (JP)

(21) Appl. No.: 14/977,705

(22) Filed: Dec. 22, 2015

(30) Foreign Application Priority Data
Jan. 5, 2015 (JP) 2015-000314

(51) Int. Cl. G06F 11/14

(52) U.S. Cl. CPC G06F 11/1469; G06F 11/1451; G06F 11/1464; G06F 2201/805; G06F 2201/84

(57) ABSTRACT

A failure monitoring device includes a selecting unit and a migration control unit. The selecting unit selects, when a failure related to software occurs in a system that is operated in one of data centers that are arranged in geographically separate locations and that can communicate with each other, an engineer who handles the failure. The migration control unit migrates, when an engineer belonging to another data center that is different from the data center in which the system is operated is selected by the selecting unit, the system to the another data center.

### CROSS-REFERENCE TO RELATED APPLICATION(S)

This application is based upon and claims the benefit of priority of the prior Japanese Patent Application No. 2015-000314, filed on Jan. 5, 2015, the entire contents of which are incorporated herein by reference.

### FIELD

The embodiments discussed herein are directed to a failure monitoring device, a computer-readable recording medium, and a failure monitoring method.

### BACKGROUND

Conventionally, there is a known technology that monitors apparatuses, such as computers or the like, and operated systems and that selects, when a failure occurs in an apparatus or a system targeted for the monitoring, a contact person who investigates or deal with the failure that has occurred.

Furthermore, in recent years, information processing systems constituted by a plurality of data centers are provided. In such information processing systems, the number of running apparatuses or the operated systems becomes huge. Consequently, if a failure occurs in an information processing system constituted by a plurality of data centers, it may sometimes be difficult for the conventional technology to handle the failure that has occurred.

Patent Document 1: Japanese Laid-open Patent Publication No. 2002-230672

Patent Document 2: Japanese Laid-open Patent Publication No. 2006-309615

Patent Document 3: Japanese Laid-open Patent Publication No. 2004-179897

However, due to permeation of an automation technology, for handling of typical failures, the range from detection to handling that can be handled by a system is expected to be increased. In contrast, for occurrence of unknown failures, it is difficult to completely automatically handle the failures in a system. For example, because it is difficult to standardize failures related to software, if such an unknown failure occurs, investigation or handling performed by engineers, i.e., persons, is requested. Consequently, in each of the data centers in the information processing system described above, even if an unknown failure occurs, the structure that can handle the unknown failure is needed. However, when the data centers in the information processing system described above are viewed as a whole, because of various reasons, such as costs, manpower limitations of engineers, or the like, it is difficult to optimize the structure of the handling, such as positioning of engineers, failures. Thus, there is a problem in that it takes time to handle a system failure in a data center in a region that is not able to be handled by an engineer.

### SUMMARY

According to an aspect of an embodiment, a failure monitoring device includes a selecting unit and a migration control unit. The selecting unit selects, when a failure related to software occurs in a system that is operated in one of data centers that are arranged in geographically separate locations and that can communicate with each other, an engineer who handles the failure. The migration control unit migrates, when an engineer belonging to another data center that is different from the data center in which the system is operated is selected by the selecting unit, the system to the another data center.

According to another aspect of an embodiment, a computer-readable recording medium has stored therein a failure monitoring program. The failure monitoring program causes a computer to execute a process. The process includes: selecting, when a failure related to software occurs in a system that is operated in one of data centers that are arranged in geographically separate locations and that can communicate with each other, an engineer who handles the failure; and migrating, when an engineer belonging to another data center that is different from the data center in which the system is operated is selected, the system to the another data center.

According to still another aspect of an embodiment, a failure monitoring method includes: selecting, performed by a computer when a failure related to software occurs in a system that is operated in one of data centers that are arranged in geographically separate locations and that can communicate with each other, an engineer who handles the failure; and migrating, performed by the computer when an engineer belonging to another data center that is different from the data center in which the system is operated is selected, the system to the another data center.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating the hardware configuration of an information processing system according to an embodiment;

FIG. 2 is a block diagram illustrating the functional configuration of a data center according to the embodiment;

FIG. 3 is a schematic diagram illustrating an example of the data structure of operating system information;

FIG. 4 is a schematic diagram illustrating an example of the data structure of failure information;

FIG. 5 is a schematic diagram illustrating an example of the data structure of requested skill information;

FIG. 6 is a schematic diagram illustrating an example of the data structure of engineer information;

FIG. 7 is a schematic diagram illustrating an example of the data structure of holding skill information;

FIG. 8 is a schematic diagram illustrating an example of the flow of a process when migration is performed;

FIG. 9 is a flowchart illustrating an example of the flow of a failure responding process;

FIG. 10 is a flowchart illustrating an example of the flow of a migration control process;

FIG. 11 is a flowchart illustrating an example of the flow of a migration destination responding process;

FIG. 12 is a schematic diagram illustrating another example of the flow of a process when migration is performed; and

FIG. 13 is a block diagram illustrating a computer that executes a failure monitoring program.

### DESCRIPTION OF EMBODIMENTS

Preferred embodiments of the present invention will be explained with reference to accompanying drawings. The embodiments are applied to an information processing system that includes therein a plurality of data centers that provides virtual machines. The present invention is not limited to the embodiments. Furthermore, the embodiments can be appropriately used in combination as long as processes do not conflict with each other.

### [a] First Embodiment

Configuration of an information processing system according to an embodiment

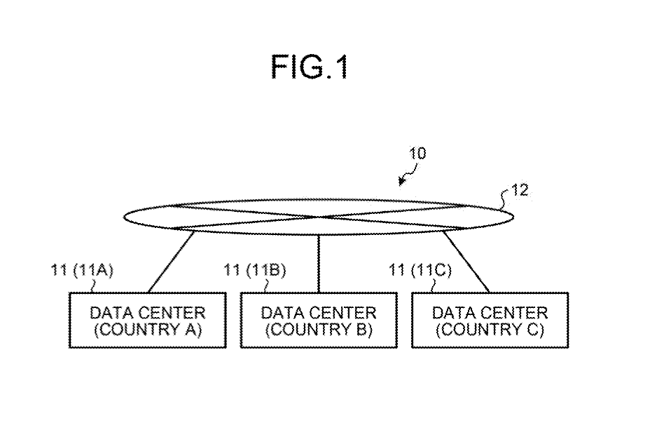

FIG. 1 is a schematic diagram illustrating the hardware configuration of an information processing system according to an embodiment. As illustrated in FIG. 1, an information processing system 10 includes a plurality of data centers (DCs) 11. Each of the data centers 11 are connected to a network 12. The network 12 may also be a dedicated line or may also be a non-dedicated line. The information processing system 10 is a system in which a virtual machine (VM) can be migrated between each of the data centers 11 via the network 12. Furthermore, in the example illustrated in FIG. 1, the three data centers 11 (11A, 11B, and 11C) are illustrated; however, an arbitrary number of data centers 11 may also be used as long two or more data centers are used.

The data centers 11 are arranged in geographically separate locations with each other. In the embodiment, it is assumed that each of the data centers 11 is arranged in a different region, such as a different country. For example, it is assumed that the data centers 11A, 11B, and 11C are set in a country A, a country B, and a country C, respectively. Furthermore, in the embodiment, a description will be given of a case, as an example, in which the three data centers 11A, 11B, and 11C are set in the country A, the country B, and the country C, respectively; however, two or more of the data centers 11 may also be set in the same country. Furthermore, a description below indicates an example in which the data center ID of “DC01” is attached to the data center 11A as the identification information that identifies the data center. Furthermore, in the example described below, the data center ID of “DC02” is attached to the data center 11B and the data center ID of “DC03” is attached to the data center 11C.

Hardware Configuration of the Data Centers

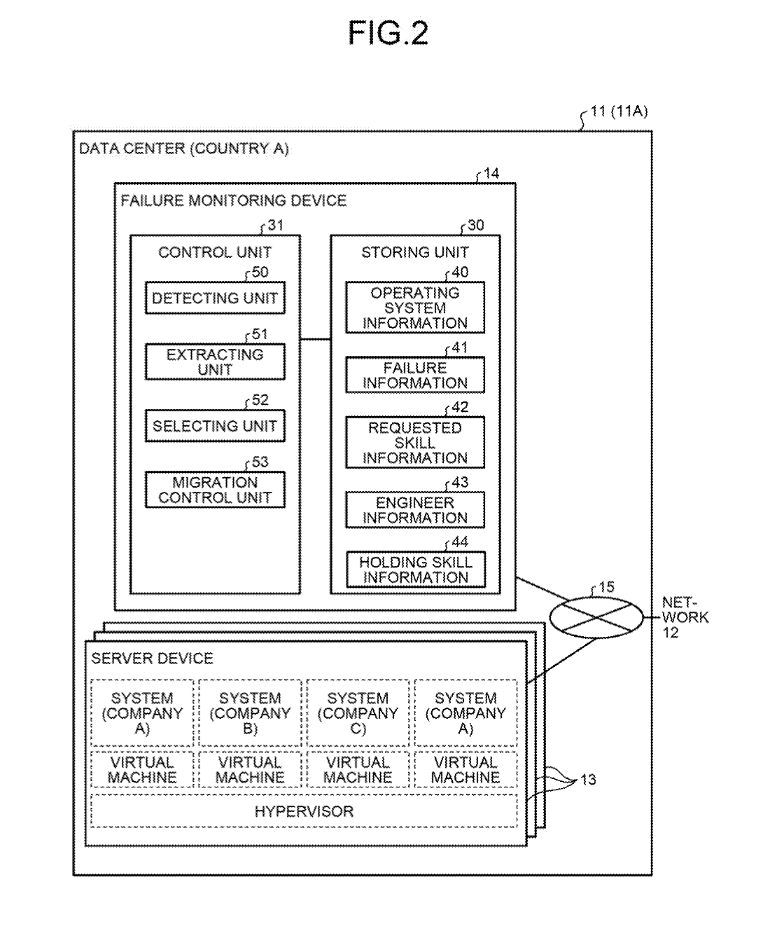

In the following, the functional configuration of the data centers 11 will be described with reference to FIG. 2. FIG. 2 is a block diagram illustrating the functional configuration of a data center according to the embodiment. The functional configurations of the data centers 11A to 11C are substantially the same; therefore, in below, the configuration of the data center 11A will be described as an example.

The data center 11 includes a plurality of server devices 13 and a failure monitoring device 14. The plurality of the server devices 13 and the failure monitoring device 14 are connected by a network 15 and can be communicated with each other. The network 15 is connected to the network 12 such that they can communicate with each other and the network 15 can be communicated with the other data centers 11 via the network 12. Furthermore, in the example illustrated in FIG. 2, the three server devices 13 are illustrated; however, an arbitrary number of server devices 13 may also be used. Furthermore, in the example illustrated in FIG. 2, a single number of the failure monitoring device 14 is illustrated; however, two or more of the failure monitoring device 14 may also be used.

The server device 13 is a physical server that operates a virtual machine formed by virtualizing a computer and that provides a user with various kinds of services and is, for example, a server computer. The server device 13 operates a plurality of virtual machines on a hypervisor by executing a server virtualization program and operates a system of a customer by operating an application program in the virtual machine in accordance with the customer. In the embodiment, as systems of customers, systems of various kinds of corporations are operated. In the example illustrated in FIG. 2, as the systems of the customers, the systems of a company A, a company B, and a company C are operated. Furthermore, the server device 13 operates, for example, the virtual machines and operates an operation state check system on the virtual machine. This operation state check system may also be a system dedicated to a check of the operation state of the data center 11 or, alternatively, a management system that manages the data center 11 may also be used for the operation state check system.

The failure monitoring device 14 is a physical server that monitors the systems operated in the server devices 13 and is, for example, a server computer. Specifically, the failure monitoring device 14 monitors a system that is operated on a virtual machine running on each of the server devices 13 and controls migration of a virtual machine by sending an instruction to migrate the virtual machine to each of the server devices 13.

The failure monitoring device 14 in each of the data centers 11 can send and receive information with each other and can be aware of the state of the other data centers 11 on the basis of the information received from the failure monitoring device 14 in each of the other data centers 11. In the information processing system 10, the failure monitoring device 14 in one of the data centers 11 is used as a failure monitoring device that manages the entirety of the information processing system 10. The failure monitoring device 14 in each of the other data centers 11 notifies the failure monitoring device 14 that is assigned to function as the failure monitoring device that manages the entirety of the information processing system 10 of the state of the data center 11. For example, the failure monitoring device 14 has the relation of master to slave between the failure monitoring devices 14 in the other data centers 11. The relation of master to slave between the failure monitoring devices may also previously be set by an administrator or may also be set by a program in accordance with a predetermined setting procedure. The slave failure monitoring devices 14 notify the master failure monitoring device 14 of the state of the data centers 11. The master failure monitoring device 14 notifies the slave failure monitoring devices 14 in the other data centers 11 of an instruction related to an operation of the data centers 11. For example, the master failure monitoring device 14 notifies the slave failure monitoring devices 14 in the other data centers 11 of a migration instruction of a virtual machine. The slave failure monitoring devices 14 execute the instruction related to the operation of the data centers 11 in accordance with the notified instruction. For example, in accordance with the migration instruction, the slave failure monitoring devices 14 instruct the server devices 13 of the migration and allow the server devices 13 to perform migration of a virtual machine. Hereinafter, the failure monitoring device 14 that becomes the master of the relation of master to slave is referred to as the “lead”. In a description below, the failure monitoring device 14 in the data center 11A is described serving as the “lead”.

Configuration of the Failure Monitoring Device

In the following, the configuration of the failure monitoring device 14 according to the first embodiment will be described. As illustrated in FIG. 2, the failure monitoring device 14 includes a storing unit 30 and a control unit 31. In addition to the functioning units illustrated in FIG. 2, the failure monitoring device 14 may also include various kinds of functioning units included in a known computer. For example, the failure monitoring device 14 may also include a displaying unit that displays various kinds of information or an input unit that inputs various kinds of information.

The storing unit 30 is a storage device that stores therein various kinds of data. For example, the storing unit 30 is a storage device, such as a hard disk, a solid state drive (SSD), an optical disk, or the like. The storing unit 30 may also be a semiconductor memory, such as a random access memory (RAM), a flash memory, a non-volatile static random access memory (NVSRAM), or the like, that can rewrite data.

The storing unit 30 stores therein operating system (OS) and various kinds of programs executed by the control unit 31. For example, the storing unit 30 stores therein various kinds of programs including programs that execute a migration control process, which will be described later. Furthermore, the storing unit 30 stores therein various kinds of data that are used by the programs executed in the control unit 31. For example, the storing unit 30 stores therein operating system information 40, failure information 41, requested skill information 42, engineer information 43, and holding skill information 44.

The operating system information 40 is data that stores therein information about the virtual machines and the systems running on each of the server devices 13. For example, in the operating system information 40, virtual machines and the systems running on the server device 13 are stored in an associated manner.

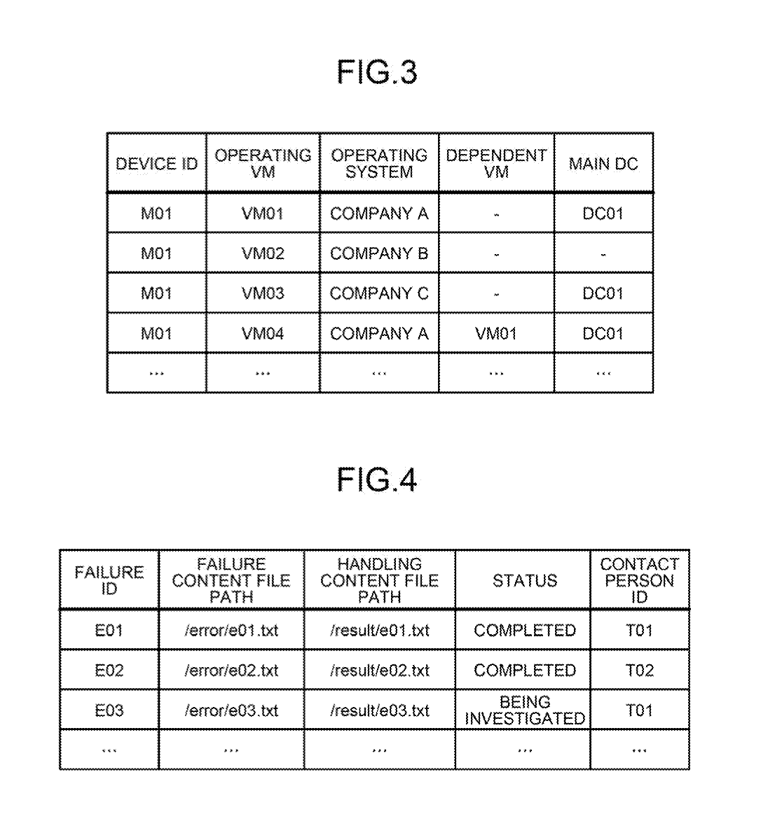

FIG. 3 is a schematic diagram illustrating an example of the data structure of operating system information. As illustrated in FIG. 3, the operating system information 40 has items of a “device ID”, an “operating VM”, an “operating system”, a “dependent VM”, and a “main DC”. The item of the device ID is an area that stores therein identification information that identifies the server devices 13. A device ID is attached to each of the server devices 13 as the identification information that identifies each of the server devices 13. In the item of the device ID, the device IDs that are attached to the server devices 13 are stored. The item of the operating VM is an area that stores therein identification information that identifies each of the virtual machines running on the server device 13 with the device ID. A machine ID is attached to a virtual machine as the identification information that identifies each of the virtual machines. The item of the operating VM stores therein machine IDs attached to the virtual machines running on the server device 13 with the device ID. The item of the operating system is an area that stores therein identification information that identifies each of the systems running on the virtual machine. The item of the operating system stores therein which of the system of a company is running on the virtual machine.

The item of the dependent VM is an area that stores therein the identification information that identifies each of the virtual machines that has the dependency relationship. In the item of the dependent VM, the machine ID attached to a virtual machine that has the dependency relationship is stored. The virtual machine that has the dependency relationship is a virtual machine that is requested to be operated in order to operate the subject virtual machine. In the example illustrated in FIG. 3, in order to operate the virtual machine with the machine ID of “VM04”, the virtual machine with the machine ID of “VM01” needs to be operated. The item of the main DC is an area that stores therein identification information that identifies the data center specified as the data center that operates the subject virtual machine. In the item of the main DC, the data center ID attached to the data center specified as the data center that operates the subject virtual machine is stored. In the example illustrated in FIG. 3, for the virtual machine with the machine ID of “VM01”, the data center with the data center ID of “DC01” is stored as the main DC.

The example illustrated in FIG. 3 indicates that, on the server device 13 with the device ID of “M01”, the virtual machine with the machine ID of “VM01” is running and indicates that, on the subject virtual machine, the system of the “company A” is running. Furthermore, the example illustrated in FIG. 3 indicates that, for the virtual machine with the machine ID of “VM01”, because the dependent VM is indicated by “-”, the dependent VM is not present and indicates that the main DC of the subject virtual machine is the data center with the data center ID of “DC01”.

The failure information 41 is data that stores therein information about a failure that has occurred in the information processing system 10. For example, the failure information 41 stores therein information about the storage location of a file in which failure content is described for each failure that has occurred in the information processing system 10, the storage location of a file in which handling content of the failure is described, the status that indicates the handling state of the failure, a handled engineer, or the like.

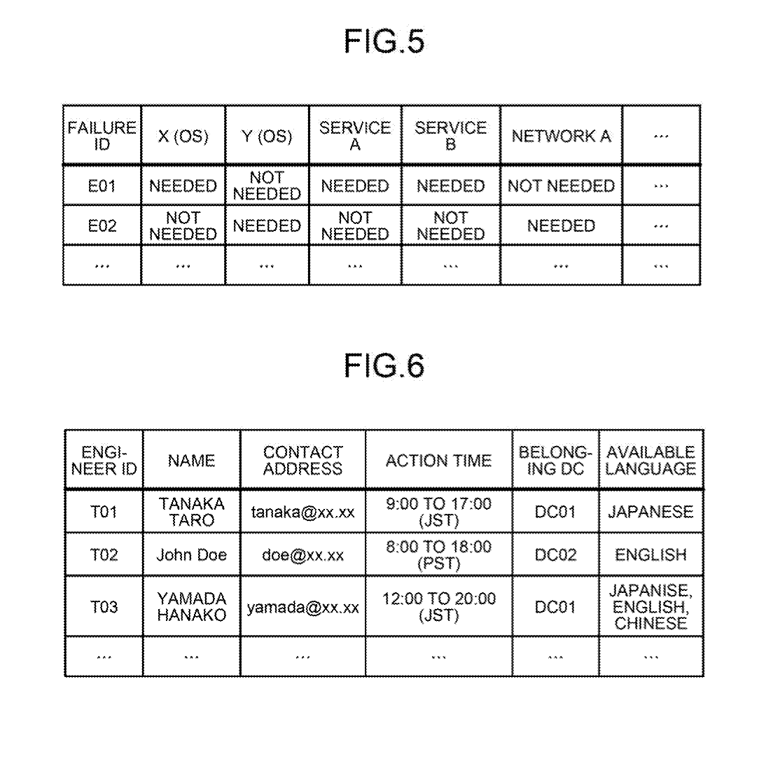

FIG. 4 is a schematic diagram illustrating an example of the data structure of failure information. As illustrated in FIG. 4, the failure information 41 has items of a “failure ID”, a “failure content file path”, a “handling content file path”, a “status”, and a “contact person ID”. The item of the failure ID is an area that stores therein identification information that identifies a failure that has occurred in the information processing system 10. A failure ID is attached to the failure that has occurred in the information processing system 10 as the identification information that identifies each failure. The item of the failure ID stores therein the failure ID attached to the failure that has occurred in the information processing system 10. The item of the failure content file path is an area that stores therein the storage location of a file in which the content of the failure that is identified by the failure ID. The item of the handling content file path is an area that stores therein the storage location of a file in which the handling content with respect to a failure identified by the failure ID is described. The item of the status is an area that stores therein the handling state of the failure identified by the failure ID. The item of the contact person ID is an area that stores therein identification information that identifies the contact person who has handled the failure that occurred in the information processing system 10. A description thereof in detail will be described with reference to FIG. 6; however, an engineer ID is attached to, as the identification information that identifies each of the engineers, the engineer who is a contact person who handles the failure that has occurred in the information processing system 10. The item of the contact person ID stores therein the engineer ID that is attached to the contact person who performed the handling of the failure that has occurred in the information processing system 10. Furthermore, if a plurality of contact persons handled a failure, a plurality of engineer IDs may also be stored.

The example illustrated in FIG. 4 indicates that, for the failure identified by “E02”, the file in which the content of the subject failure is described is stored in “/error/e02.txt” and the file in which the handling content of the subject failure is described is stored in “/result/e02.txt”. Furthermore, the example illustrated in FIG. 4 indicates that, for the failure identified by “E02”, handling thereof has been completed and the contact person who performed the handling thereof is the engineer that is identified by “T02”. The example illustrated in FIG. 4 indicates that, for the failure that is identified by “E03”, the file in which the content of the subject failure is described is stored in “/error/e03.txt” and the file in which the content of the handling performed on the subject failure is stored in “/result/e03.txt”. Furthermore, the example illustrated in FIG. 4 indicates that, for the failure identified by “E03”, the handling state is being investigated and the contact person who is handling the failure is the engineer identified by “T01”.

The requested skill information 42 is data that stores therein information indicating whether an engineer handling each failure that occurs in the information processing system 10 needs to have an ability (hereinafter, sometimes referred to as a “skill”). For example, the requested skill information 42 stores therein information indicating whether a skill related to various kinds of OSs for each failure is requested, whether a skill related to various kinds of services is requested, whether a skill related to various kinds of networks is requested, or the lie.

FIG. 5 is a schematic diagram illustrating an example of the data structure of requested skill information. As illustrated in FIG. 5, the requested skill information 42 has items of a “failure ID”, an “X (OS)”, a “Y (OS)”, a “service A”, a “service B”, a “network A”, and the like. The item of the failure ID is an area that stores therein the failure ID attached to a failure that occurs in the information processing system 10. The item of the X (OS) is an area that stores therein information indicating whether the skill related to the X (OS) has been requested in order to handle the failure identified by the failure ID. The item of the Y (OS) is an area that stores therein information indicating whether the skill related to the Y (OS) has been requested to handle the failure identified by the failure ID. The item of the service A is an area that stores therein information indicating whether the skill related to the service A has been requested to handle the failure identified by the failure ID. The item of the service B is an area that stores therein information indicating whether the skill related to the service B has been requested to handle the failure identified by the failure ID. The item of the network A is an area that stores therein information indicating whether the skill related to the network A has been requested to handle the failure identified by the failure ID.

The example illustrated in FIG. 5 indicates that, for the handling of the failure that is identified by “E01”, the skill related to the X (OS) is requested and the skill related to the Y (OS) is not requested. Furthermore, the example illustrated in FIG. 5 indicates that, for the handling of the failure that is identified by “E01”, the skills related to the service A and the service B are requested and the skill related to the network A is not requested. Furthermore, in the example illustrated in FIG. 5, the skill requested for the failure “E03” in which the handling has not been completed is not stored; however, for the failure “E03” that is being investigated, a skill requested at the step of being investigated may also be stored.

The engineer information 43 is data that stores therein information about the engineers registered in the information processing system 10. For example, the engineer information 43 is data that stores therein information about the engineers belonging to each of the data centers. Furthermore, for example, the engineer information 43 stores therein information about the engineer ID, the name, the contact address of an engineer, the action time of an engineer, the data center to which an engineer belongs, the language that can be used by an engineer, or the like.

FIG. 6 is a schematic diagram illustrating an example of the data structure of engineer information. As illustrated in FIG. 6, the engineer information 43 has items of the “engineer ID”, the “name”, the “contact address”, the “action time”, “belonging DC”, and an “available language”. The item of the engineer ID is an area that stores therein the identification information that identifies the engineers registered in the information processing system 10. An engineer ID is attached to the engineers registered in the information processing system 10 as the identification information that identifies the engineers. The item of the engineer ID stores therein the engineer ID attached to each of the engineers registered in the information processing system 10. The item of the name is an area that stores therein the name of the engineer that is identified by the engineer ID. The item of the contact address is an area that stores therein the contact address (for example, an email address, a phone number, or the like) of the engineer identified by the engineer ID. The item of the action time is an area that stores therein the time occupied by the engineer identified by the engineer ID. The item of the belonging DC is an area that stores therein the data center ID that identifies the data center to which the engineer identified by the engineer ID belongs. The item of the available language is an area that stores therein the language that can be used by the engineer identified by the engineer ID. Furthermore, the information is not limited to the information indicated the above, the engineer information 43 may also include therein various kinds of information, such as information about a non-working day of an engineer.

The example illustrated in FIG. 6 indicates that the engineer identified by “T01” is the engineer whose name is “Tanaka Taro”, the contact address thereof is “tanaka@xx.xx”, and the action time is 9:00 to 17:00 (JST). Furthermore, the example illustrated in FIG. 6 indicates that, for the engineer identified by “T01”, the data center ID of the data center to which the engineer belongs is “DC01” and the available language is “Japanese”. Furthermore, “JST” indicated in the item of the “action time” in FIG. 6 stands for Japan Standard Time and “PST” stands for Pacific Standard Time. Furthermore, “Japanese” in the item of the “available language” illustrated in FIG. 6 indicates the Japanese language, “English” indicates the English language, and “Chinese” indicates the Chinese language.

The holding skill information 44 is data that stores therein information about the skills held by the engineers registered in the information processing system 10. For example, the holding skill information 44 stores therein information indicating, for each failure, whether an engineer has the skill related to various kinds of OSs, whether an engineer has the skill related to various kinds of services, whether an engineer has the skill related to various kinds of networks, or the like.

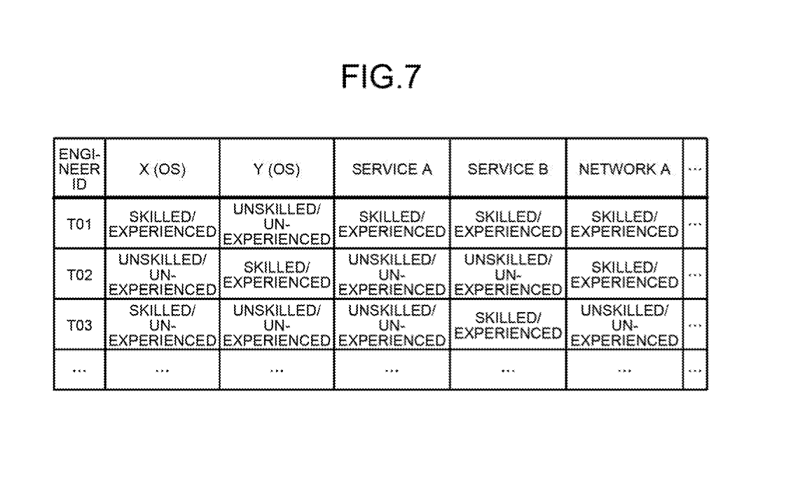

FIG. 7 is a schematic diagram illustrating an example of the data structure of holding skill information. As illustrated in FIG. 7, the holding skill information 44 has items of the “engineer ID”, the “X (OS)”, the “Y (OS)”, the “service A”, the “service B”, the “network A”, and the like. The item of the engineer ID is an area that stores therein the engineer IDs attached to the engineers registered in the information processing system 10. The item of the X (OS) is an area that stores therein information indicating whether the engineer identified by the engineer ID has the skill or the like related to the X (OS). The item of the Y (OS) is an area that stores therein information indicating whether the engineer identified by the engineer ID has the skill or the like related to the Y (OS). The item of the service A is an area that stores therein information indicating whether the engineer identified by the engineer ID has the skill or the like related to the service A. The item of the service B is an area that stores therein information indicating whether the engineer identified by the engineer ID has the skill or the like related to the service B. The item of the network A is an area that stores therein information indicating whether the engineer identified by the engineer ID has the skill or the like related to the network A.

The example illustrated in FIG. 7 indicates that the engineer identified by “T01” has the skill and the experience related to the X (OS) and does not have the skill and the experience related to the Y (OS). Furthermore, the example illustrated in FIG. 7 indicates that the engineer identified by “T01” has the skill and the experience related to the service A, the service B, and the network A.

A description will be given here by referring back to FIG. 2. The control unit 31 is a device that controls the failure monitoring device 14. As the control unit 31, an electronic circuit, such as a central processing unit (CPU), a micro processing unit (MPU), and the like, or an integrated circuit, such as an application specific integrated circuit (ASIC), a field programmable gate array (FPGA), and the like, may be used. The control unit 31 includes an internal memory that stores therein control data and programs in which various kinds of procedures are prescribed, whereby various kinds of processes are executed. The control unit 31 functions as various kinds of processing units by various kinds of programs being operated. For example, the control unit 31 includes a detecting unit 50, an extracting unit 51, a selecting unit 52, and a migration control unit 53.

The detecting unit 50 detects a failure that occurs in a system operated in a data center. For example, the detecting unit 50 detects an operation state of the data center 11. For example, the detecting unit 50 detects, as the operation state of the data center 11, the occurrence state of a failure in an operation state check system running in the data center 11. For example, the detecting unit 50 detects whether a failure occurs on the basis of a log of the Basic Input Output System (BIOS) of the server device 13 in which the operation state check system is operated, a thermal error, an event log of an OS of a virtual machine, a monitoring ALARM message, or the like. Furthermore, the detecting unit 50 determines whether the failure that has occurred is a failure related to hardware or a failure related to software. For example, on the basis of the log of the BIOS or the event log of the OS of the virtual machine described above, the detecting unit 50 may also determine whether the failure that has occurred is a failure related to hardware or a failure related to software. Furthermore, for example, if redundant configuration is used and an automatic change is set when a failure related to hardware occurs, the detecting unit 50 may also determine that the failure that continuously outputs errors even if a predetermined period time has elapsed is the failure related to software. Furthermore, the determination of the failure related to the hardware or the failure related to the software performed by the detecting unit 50 described above is an example. The detecting unit 50 may also determine, on the basis of various kinds of technologies, whether the failure that has occurred is a failure related to hardware or a failure related to software.

Furthermore, in the failure monitoring device 14 acquires, from the failure monitoring device 14 in each of the other data centers 11, information about a failure that has occurred. For example, the detecting unit 50 in the failure monitoring device 14 in the data center 11A acquires the information about the failure that has occurred in the failure monitoring device 14 in each of the other data centers 11. When a failure occurs in a subject data center, the information about the failure that has occurred may also appropriately be sent by the failure monitoring device 14 in the subject other data center 11.

The extracting unit 51 extracts an engineer who can handle the failure that has occurred. The extracting unit 51 extracts an engineer who can handle the failure on the basis of, for example, the skills of the engineers stored in the holding skill information 44 in the storing unit 30. For example, the extracting unit 51 estimates a skill requested to handle the failure detected by the detecting unit 50 from the information about past failures stored in the failure information 41, the requested skill information 42, or the like. For example, the extracting unit 51 may search the failure information 41 in the storing unit 30 for a past failure in which the same problem as that currently occurs in the current failure and may estimate the skill requested by the searched past failure as the skill that is currently requested to handle the failure that has occurred. Furthermore, the extracting unit 51 may also estimate the skill requested for the failure in which the same problem occurred in a past and that is being investigated as the skill currently requested to handle the failure that occurs. Then, the extracting unit 51 extracts the engineer who has the estimated skill. Specifically, if a failure related to software has occurred, the extracting unit 51 extracts an engineer who has the estimated skill and the time at which the failure has occurred falls on the action time of that engineer. For example, in the examples illustrated in FIGS. 4 to 7, if a failure occurs at 13:00 (JST) and the skill of the service B is requested to handle the subject failure, at least two engineers with the engineer ID of “T01” and “T03” are extracted. Furthermore, if, for example, the day in which a failure occurs falls on a non-working day of an engineer stored in the engineer information 43, the extracting unit 51 does not need to extract the subject engineer.

Furthermore, the extracting unit 51 estimates a language requested to handle the failure and does not need to extract an engineer whose available language is not included in the subject language. In this case, the extracting unit 51 may also estimate the language that is used in the country in which the data center in which the failure has occurred is located as the language requested to handle the failure. For example, the extracting unit 51 may also estimate an available language that is previously stored in the storing unit 30 for each country as the language requested to handle the failure.

When the extracting unit 51 estimates a skill requested to handle the failure detected by the detecting unit 50, the extracting unit 51 may also extract an engineer who can handle the failure by taking into account the experience of the skill. For example, if the experience is also requested in addition to the skill of the “X (OS)”, the extracting unit 51 does not extract the engineer “T03” who has the skill of the “X (OS)” but has no experience. If the extracting unit 51 estimates a plurality of skills requested to handle the failure detected by the detecting unit 50, the extracting unit 51 may also extract only the engineer who has all of the skills that are estimated as the requested skills. Furthermore, the extracting unit 51 may also extract an engineer who has skills the number of which is equal to or greater than a predetermined number of skills from among the skills estimated as the requested skills. For example, if the number of skills estimated as the requested skills is five, the extracting unit 51 may also extract an engineer who has skills the number of which is equal to or greater than three out of the five skills. Furthermore, the extracting unit 51 allocates a weighting value to each of the multiple skills estimated as the requested skills and may also extract an engineer who has skills in which the sum of the weighting value exceeds a threshold. Furthermore, the extracting unit 51 classifies the multiple skills estimated as the requested skills into fundamental skills and optional skills and may also extract an engineer who has the fundamental skills and has the optional skills the number of which is equal to or greater than a predetermined number. The extraction of an engineer who handles a failure by the extracting unit 51 described above is only an example and the extracting unit 51 may also extract an engineer based on various criteria in accordance with a failure that occurs or in accordance with a purpose of the handling.

Furthermore, if a plurality of extracted engineers is present, the extracting unit 51 may also prioritize the extracted plurality of engineers. In this case, the extracting unit 51 may also give a higher priority to an engineer whose action time is longer from the time at which the failure has occurred. For example, if a failure occurs at 13:00 (JST) and if the engineer “T01” and the engineer “T03” are extracted as the available engineers, a first priority may also be given to the engineer “T03” whose action time is longer from 13:00 (JST). The extracting unit 51 may also give a higher priority to an engineer who uses, as the available language, the language that is requested to handle the failure. For example, if the engineer “T01” and the engineer “T03” are extracted as the engineer who can handle the failure and if the Chinese language is estimated to be requested to handle the failure, a first priority may also be given to the engineer“T03” who holds the Chinese language as the available language. Furthermore, the extracting unit 51 may also give a higher priority to an engineer who has a greater number of skills estimated as the requested skills. Furthermore, the extracting unit 51 may also give a higher priority to an engineer who has skills in which the sum of weighting values is greater. The prioritization of engineers how handle a failure by the extracting unit 51 described above is only an example and the extracting unit 51 may also prioritize the engineers based on various criteria in accordance with a failure that occurs or a purpose of the handling.

The selecting unit 52 selects an engineer how handles the failure from among the engineers extracted by the extracting unit 51. For example, if the two engineers with the engineer ID of “T01” and “T02” are extracted by the extracting unit 51, the selecting unit 52 selects, between the two engineers “T01” and “T02”, an engineer who is allowed to handle the failure. The selecting unit 52 selects an engineer belonging to the data center in which a system in which the failure has occurred is operated by giving a higher priority than the engineers belonging to the other data centers. For example, if a failure has occurred in the data center 11B that is identified by “DC02” and if two engineers with the engineer ID of “T01” and “T02” are extracted by the extracting unit 51, the selecting unit 52 selects, with priority, the engineer “T02” belonging to the data center 11B. Furthermore, if a priority is given to the engineer extracted by the extracting unit 51, the selecting unit 52 may also select an engineer to whom a higher priority is given.

The migration control unit 53 performs migration of the virtual machine. Specifically, if an engineer who belongs to another data center that is different from the data center in which the system in which the failure has occurred is operated is selected by the selecting unit 52, the migration control unit 53 migrates the system, in which the failure has occurred, to the other data center. Furthermore, the migration control unit 53 performs the migration of a virtual machine only when a failure related to software occurs. For example, if a failure occurs in the data center 11A of “DC01” and if an engineer “T02” belonging to the data center 11B is selected by the selecting unit 52, the migration control unit 53 migrates the system in which the failure has occurred to the data center 11B of “DC02”.

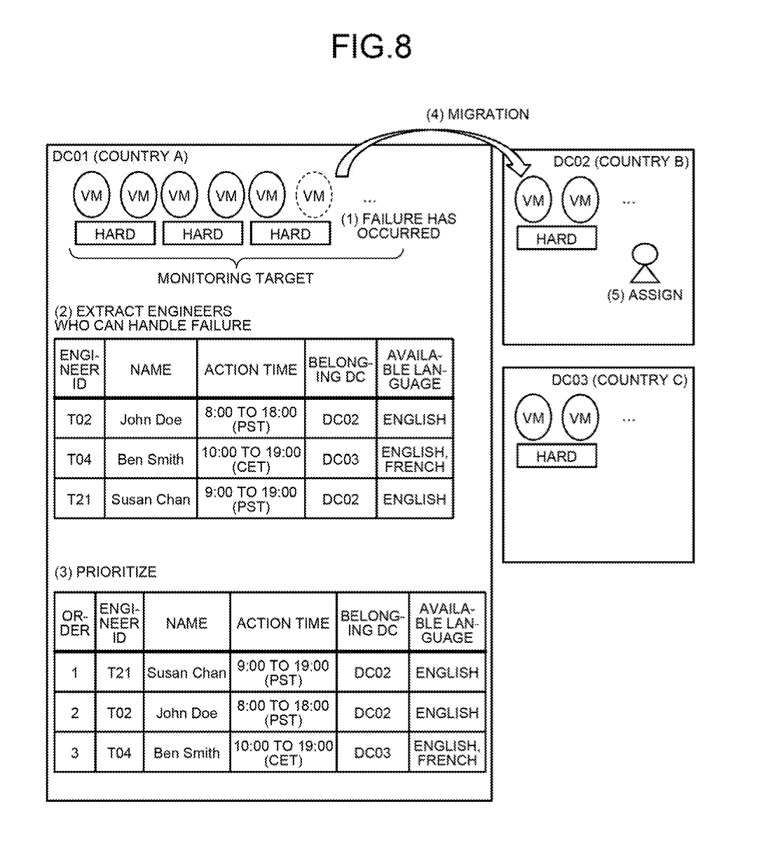

FIG. 8 is a schematic diagram illustrating an example of the flow of a process when migration is performed. In FIG. 8, a description will be given of a case in which the country A is Japan, the country B is the United States of America, the data center 11B identified by “DC02” is located in the west coast of the United States, and the country C is France. In the example illustrated in FIG. 8, a plurality of systems is operated in the data center (DC01) in the country A. In the following, a description will be given of an example in which, from among the plurality of systems in the data center (DC01) in the country A, a failure related to software has occurred in a single system (the “VM” surrounded by the dotted line illustrated in FIG. 8) ((1) illustrated in FIG. 8).

First, the extracting unit 51 extracts engineers who can handle the failure that has occurred ((2) illustrated in FIG. 8). In the example illustrated in FIG. 8, if a failure related to software has occurred in a single system in the data center (DC01) in the country A, the extracting unit 51 estimates the skills requested to handle the subject failure from the information about handling of the past failures, such as the failure information 41 or the requested skill information 42. Then, the extracting unit 51 extracts an engineer who has the estimated skills and the time at which the failure has occurred is included in the action time of that engineer. The example illustrated in FIG. 8 indicates the case in which the failure occurs at 2:00 (JST) in the data center (DC01) in the country A. The extracting unit 51 extracts the engineer who has the estimated skills and the subject time is included in the action time. When the time at the data center (DC01) in the country A is 2:00 (JST), the time at the data center (DC02) located in the west coast of the country B falls on 9:00 (PST). Furthermore, when the time at the data center (DC01) in the country A is 2:00 (JST), the time at the data center (DC03) in the country C is 18:00 (Central European Time (CET)) on the previous day.

In the example illustrated in FIG. 8, the extracting unit 51 estimates that a skill related to a network A is requested to handle the failure that has occurred in the data center (DC01) in the country A. Consequently, the extracting unit 51 extracts the engineer who has the skill related to the network A and the time at which the failure has occurred is included in the action time of that engineer. In the example illustrated in FIG. 8, the extracting unit 51 extracts the engineer “T02”, the engineer “T04”, and the engineer “T21” are extracted. For example, the action time of the engineer “T02” is from 8:00 to 18:00 (PST), which includes the time 9:00 (PST) at which the failure has occurred. Furthermore, the action time of the engineer “T04” is from 10:00 to 19:00 (CET), which includes the time 18:00 (CET) at which the failure has occurred. Furthermore, the engineer “T01” has the skill related to the network A but is not extracted because the action time is from 9:00 to 17:00 (JST) that does not include the time 2:00 (JST) at which the failure has occurred.

The extracting unit 51 prioritizes the plurality of extracted engineers ((3) illustrated in FIG. 8). In the example illustrated in FIG. 8, the extracting unit 51 gives a higher priority to the engineer whose action time is longer from the time at which the failure has occurred. Here, the action time of the engineer “T21” is from 9:00 to 19:00 (PST) and the action time is 10 hours from the time 9:00 (PST) at which the failure has occurred. In contrast, the action time of the engineer “T02” is from 8:00 to 18:00 (PST) and the action time is 9 hours from the time 9:00 (PST) at which the failure has occurred. Consequently, the priority is higher for the engineer “T21” than the engineer “T02”. In the example illustrated in FIG. 8, the extracting unit 51 gives a first priority to the engineer “T21”, a second priority to the engineer “T02”, and a third priority to the engineer “T04”.

Then, because the engineers extracted by the extracting unit 51 have been prioritized, the selecting unit 52 selects an engineer who has a higher priority. In the example illustrated in FIG. 8, the selecting unit 52 selects the engineer “T21” to whom a first priority is given.

Here, in the example illustrated in FIG. 8, a failure related to software has occurred in the system in the data center (DC01) in the country A. Furthermore, the selecting unit 52 selects the engineer “T21” belonging to another data center (DC02) that is different from the data center (DC01) in which the system in which the failure has occurred is operated. Thus, the migration control unit 53 migrates the system, in which the failure has occurred, in the data center (DC01) to the data center (DC02) in the country B. Specifically, the migration control unit 53 migrates the virtual machine (VM) in which the failure has occurred to the data center (DC02) ((4) illustrated in FIG. 8).

Then, in the data center at the migration destination, the engineer selected by the selecting unit 52 handles the failure. Specifically, in the data center (DC02) in which the virtual machine in which the failure has occurred is migrated, the engineer “T21” is assigned to handle the subject failure ((5) illustrated in FIG. 8).

Flow of a Process

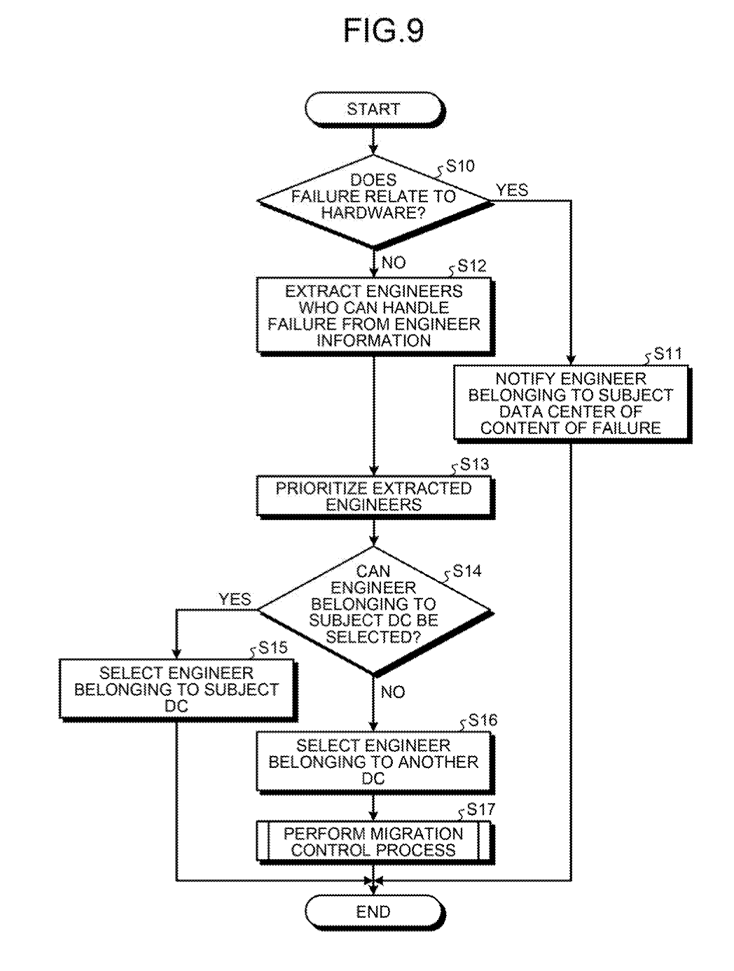

In the following, a description will be given of the flow of a failure responding process performed when a failure occurs in a system monitored by the failure monitoring device 14 according to the first embodiment. FIG. 9 is a flowchart illustrating an example of the flow of the failure responding process. This failure responding process is performed when a failure occurs in a system monitored by the failure monitoring device 14. Furthermore, in the following, a description will be given in a case in which the systems in the respective companies are operated in the data center 11 (DC01) in the country A and the failure monitoring device 14 in the data center 11 in the country A performs the failure responding process. In a description below, if a machine ID (for example, a “VM01” or the like) is described, this sometimes indicates the virtual machine that is identified by that machine ID.

As illustrated in FIG. 9, if the detecting unit 50 detects that a failure occurs, the detecting unit 50 determines whether the failure that has occurred is a failure related to hardware or a failure related to software (Step S10). If the failure that has occurred is a failure related to hardware (Yes at Step S10), the detecting unit 50 sends a notification to the engineer belonging to the data center (hereinafter, referred to as the “subject DC”) in which the failure has occurred (Step S11) and ends the process.

In contrast, if the failure that has occurred is not the failure related to hardware, i.e., the failure that has occurred relates to software (No at Step S10), the extracting unit 51 extracts the engineers who can handle the failure from the engineer information (Step S12). Then, the extracting unit 51 prioritizes the extracted engineers (Step S13).

Then, if the selecting unit 52 is able to select the engineer belonging to the subject DC (Yes at Step S14), the selecting unit 52 selects the engineer belonging to the subject DC as the engineer who handles the failure (Step S15) and ends the process. Furthermore, the engineer belonging to the subject DC selected at Step S15 is assigned as the contact person who handles the failure that has occurred and then handles the failure.

If the selecting unit 52 is not able to select an engineer belonging to the subject DC (No at Step S14), the selecting unit 52 selects the engineer who belongs to another DC that is different from the subject DC as the engineer who handles the failure (Step S16). Then, after the migration control unit 53 performs the migration control process (Step S17), the failure responding process is ended.

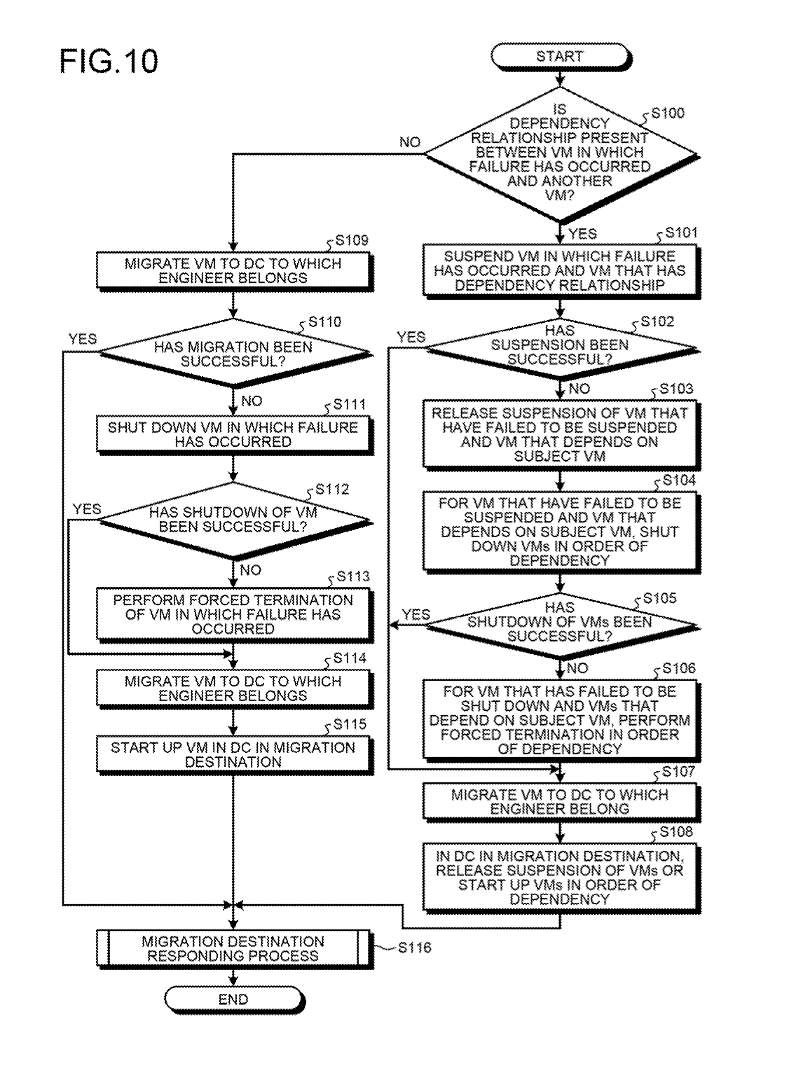

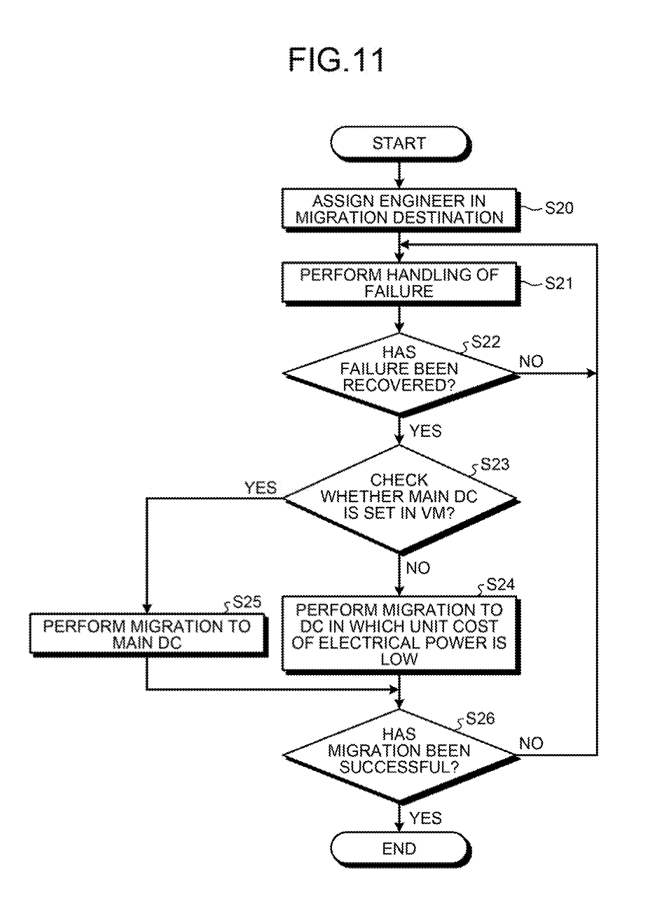

In the following, the flow of a migration control process that is a part of the failure responding process will be described with reference to FIGS. 10 and 11. FIG. 10 is a flowchart illustrating an example of the flow of a migration control process. First, the migration control unit 53 determines whether a dependency relationship is present between the VM in which the failure has occurred and another VM (Step S100). The VM that has the dependency relationship with the other VM means the VM, in the example illustrated in FIG. 3, such as the VM04 or the like, that has the relationship with the VM01 as the dependent VM.

If the dependency relationship is present between the VM in which the failure has occurred and the other VM (Yes at Step S100), the migration control unit 53 suspends the VM in which the failure has occurred and the VM that has the dependency relationship (Step S101). For example, in the example illustrated in FIG. 3, if the VM in which the failure has occurred is the VM04, the migration control unit 53 suspends the VM04 as well as the VM01 that has the dependency relationship.

If the suspension of the VM in which the failure has occurred and the VM that has the dependency relationship has been successful (Yes at Step S102), the migration control unit 53 migrates the VM to the DC to which the engineer selected by the selecting unit 52 belongs (Step S107). The processes performed at Step S107 and the subsequent processes will be described later.

If the suspension of the VM in which the failure has occurred and the VM that has the dependency relationship has failed (No Step S102), the migration control unit 53 releases the suspension of the VM that have failed to be suspended and the VM that depends on the subject VM (Step S103). Then, for the VM that have failed to be suspended and the VM that depends on the subject VM, the migration control unit 53 shuts down the VMs in the order of dependency (Step S104). For example, in the example illustrated in FIG. 3, if the VM in which the failure has occurred is the VM04, the migration control unit 53 shuts down the VM04 and then shuts down the VM01.

For the VM or the like that have failed to be suspended, if a shutdown has been successful in the order of dependency (Yes at Step S105), the migration control unit 53 migrates the VM to the DC to which the engineer selected by the selecting unit 52 belongs (Step S107). The processes performed at Step S107 and the subsequent steps will be described later.

In contrast, if a shutdown has failed in the order of dependency (No at Step S105), for the VM that has failed to be shut down and the VMs that depend on the VM, the migration control unit 53 performs forced termination in the order of dependency (Step S106). The migration control unit 53 migrates the VM to the DC to which the engineer selected by the selecting unit 52 belongs (Step S107).

Specifically, at Step S107, the migration control unit 53 migrates the VM in which the failure has occurred and VM that has the dependency relationship to the DC to which the engineer selected by the selecting unit 52 belongs. Then, in the DC at the migration destination, the migration control unit 53 releases the suspension of the VMs or starts up the VMs in the order of dependency (Step S108). For example, in the example illustrated in FIG. 3, if the VM in which the failure has occurred is the VM04, after the migration control unit 53 releases the suspension of the VM01 or starts up the VM01, the migration control unit 53 releases the suspension of the VM04 or starts up the VM04. Then, after performing the migration destination responding process (Step S116) the migration control unit 53 ends the migration control process.

In contrast, if no dependency relationship is present between the VM in which the failure has occurred and the other VMs (No at Step S100), the migration control unit 53 migrates the VM to the DC to which the engineer selected by the selecting unit 52 belongs (Step S109). If the migration has been successful (Yes at Step S110), the migration control unit 53 performs the migration destination responding process (Step S116) and then ends the migration control process.

If the migration has failed (No at Step S110), the migration control unit 53 shuts down the VM in which the failure has occurred (Step S111). If a shutdown of the VM has been successful (Yes at Step S112), the migration control unit 53 migrates the VM to the DC to which the engineer selected by the selecting unit 52 belongs (Step S114).

IF the shutdown of the VM has failed (No at Step S112), the migration control unit 53 performs the forced termination of the VM in which the failure has occurred (Step S113). Then, the migration control unit 53 migrates the VM to the DC to which the engineer selected by the selecting unit 52 belongs (Step S114).

At Step S114, after migrating the VM to the DC to which the engineer selected by the selecting unit 52 belongs, the migration control unit 53 starts up the VM in the DC at the migration destination (Step S115). Then, after the migration control unit 53 performs the migration destination responding process (Step S116), the migration control unit 53 ends the migration control process.

In the following, the flow of the migration destination responding process that is a part of the migration control process will be described with reference to FIG. 11. FIG. 11 is a flowchart illustrating an example of the flow of a migration destination responding process. First, the migration control unit 53 assigns an engineer at the migration destination (Step S20). Specifically, the migration control unit 53 assigns the engineer selected by the selecting unit 52 as a contact person who handles the failure.

Then, the engineer assigned as the contact person who handles the failure handles the failure (Step S21). For the time period in which the engineer completes the handling of the failure (No at Step S22), the migration control unit 53 periodically the state of the handling of the failure and waits until the handling of the failure is completed. For example, for the time period in which the engineer has completed the handling of the failure, the migration control unit 53 periodically checks whether the status of the associated failure ID in the failure information 41 has been completed. If the engineer has completed the handling of the failure and the failure has been recovered (Yes at Step S22), the migration control unit 53 checks whether the main DC is set in the VM in which the failure has occurred (Step S23). If the main DC is not set in the VM in which the failure has occurred (No at Step S23), the migration control unit 53 performs the migration to the DC in which a unit cost of electrical power is low (Step S24). For example, in the example illustrated in FIG. 3, the main DC is not set in the VM02. Accordingly, if the VM in which the failure has occurred is the VM02 and if a failure has been recovered after the migration from the data center of the DC01 to the data center of the DC02, the migration control unit 53 migrates the VM02 to the DC in which a unit cost of electrical power is low. For example, the data center DC03 is the DC in which the unit cost of electrical power is the lowest, the migration control unit 53 migrates the VM02 to the data center DC03.

In contrast, if the main DC is set in the VM in which the failure has occurred (Yes at Step S23), the migration control unit 53 performs the migration to the main DC (Step S25). For example, in the example illustrated in FIG. 3, for the VM03, the DC01 is set as the main DC. Thus, if the VM in which the failure has occurred is the VM03 and if the failure is recovered after the migration is performed from the data center DC01 to the data center DC02, the migration control unit 53 migrates the VM03 to the DC01 that is the main DC.

If the migration performed at Step S24 or Step S25 has been successful (Yes at Step S26), the migration destination responding process is ended. In contrast, if the migration performed at Step S24 or Step S25 has failed (No at Step S26), the processes at Steps S21 to S25 are repeatedly performed.

Advantages

As described above, the failure monitoring device 14 according to the first embodiment includes the selecting unit 52 and the migration control unit 53. The selecting units 52 are arranged in the several locations that are geographically separated with each other and select, if a failure related to software occurs in the system that is operated in the data center 11 that can communicate with each other, an engineer who handles the failure. If an engineer belonging to another data center 11 that is different from the data center 11 in which the system in which the failure has occurred is operated is selected by the selecting unit 52, the migration control unit 53 migrates the system in which the failure has occurred to the other data center 11. Consequently, the failure monitoring device 14 can promptly handle the failure that occurs in the system in the data center 11 in the region that is not handled by the engineer.

Furthermore, the failure monitoring device 14 according to the first embodiment selects the engineer belonging to the data center 11 in which the system in which the failure has occurred by giving the priority higher than that given to the engineers who belong to the other data centers 11. Consequently, if the engineer belonging to the data center 11 in which the system in which the failure has occurred is operated can handle the failure, the failure monitoring device 14 can promptly the handling of the failure of the system by allowing the subject engineer to handle the failure. Furthermore, the failure monitoring device 14 can reduce the number of occurrence of migration and can suppress the occurrence of unneeded migration.

Furthermore, the failure monitoring device 14 according to the first embodiment includes the storing unit 30 and the extracting unit 51. The storing unit 30 stores therein information about the skills of the engineers belonging to the data center 11. The extracting unit 51 extracts, on the basis of the skills of the engineers stored in the storing unit 30, the engineers who can handle the failure. Consequently, the failure monitoring device 14 can appropriately select an engineer who is allowed to handle the failure on the basis of the skills of the engineers.

Furthermore, the failure monitoring device 14 according to the first embodiment extracts, on the basis of both the action time at which the engineers stored in the storing unit 30 can handle the failure and the time at which the failure has occurred, the engineers whose action time is included in the time at which the failure has occurred. Consequently, the failure monitoring device 14 can allow the engineer who can handle the failure in terms of time to handle the failure at the time at which the failure occurs and thus promptly handle the failure in the system.

### [b] Second Embodiment

In the above explanation, a description has been given of the embodiment of the device disclosed in the present invention; however, the present invention can be implemented with various kinds of embodiments other than the embodiment described above. Therefore, another embodiment included in the present invention will be described below.

For example, the embodiment described above is directed to a case in which an engineer who can handle a failure, which has occurred, alone is present, i.e., a single engineer has all the skills requested to handle the failure that has occurred; however, the disclosed device is not limited thereto. For example, if no engineer who can handle a failure that has occurred in the data center 11 is present from among the engineers belonging to the data center 11 in which the failure has occurred, it may also possible to select an engineer who can handle the failure as follows. For example, if a plurality of skills is requested to handle the failure and a plurality of engineers who has the requested skills is present, the selecting unit 52 may also select a plurality of engineers who meet all of the requested skills if the skills held by the plurality of engineers belonging to the same data center 11 are combined. Specifically, if a plurality of engineers belongs to the same data center 11 and if the requested skills are satisfied when the skills held by the plurality of engineers whose action time is included in the time at which the failure has occurred are combined, the selecting unit 52 may also select the plurality of engineers belonging to the same data center 11.

Consequently, even if a failure that is not able to be handled by a single engineer occurs, by handling the failure by the plurality of engineers belonging to the data center 11 in the same region, the failure monitoring device 14 can promptly handle the failure.

### [c] Third Embodiment

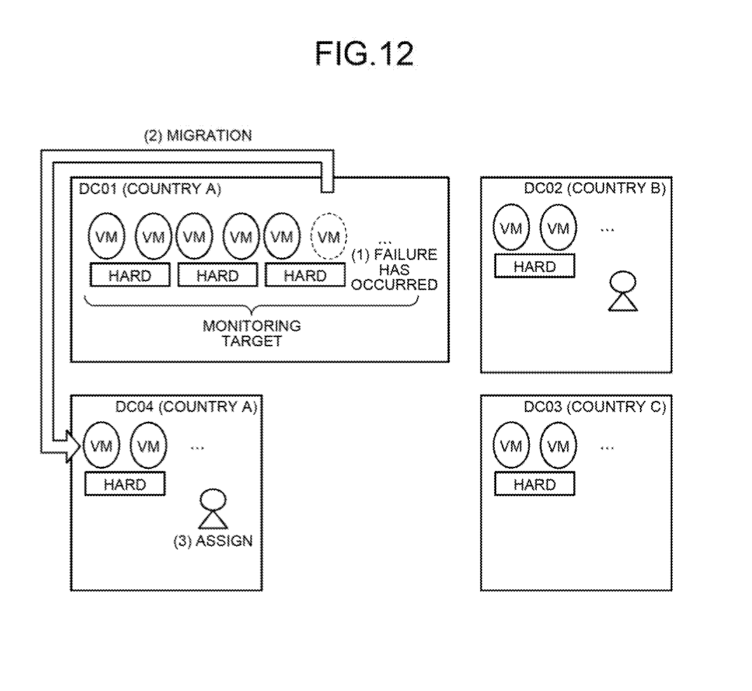

Furthermore, for example, the embodiment described above is directed to a case in which a single data center is arranged each country; however, a plurality of data centers may also be arranged in each country. In the following, a migration process will be described by using an example of a case in which two data centers are arranged in the country A. FIG. 12 is a schematic diagram illustrating another example of the flow of a process when migration is performed. In the example illustrated in FIG. 12, in the country A, a plurality of data centers including the data center DC01 and the data center DC04 is arranged. In the example illustrated in FIG. 12, a plurality of systems is operated in the data center DC01 that is arranged in the country A. In the following, a description will be given of an example of a case in which a failure related to software has occurred ((1) illustrated in FIG. 12) in a single system (the “VM” surrounded by the dotted line illustrated in FIG. 12) from among the plurality of systems in the data center DC01. First, the extracting unit 51 extracts engineers who can handle the failure that has occurred. In the example illustrated in FIG. 12, the extracting unit 51 extracts the engineer belonging to the data center DC02 and the engineer belonging to the data center DC04.

Here, in the example illustrated in FIG. 12, both the data center DC04 and the data center DC01, in which the failure has occurred, are arranged in the same country A. Thus, from among the engineers extracted by the extracting unit 51, the selecting unit 52 selects, with priority, the engineer belonging to the data center DC04 that is arranged in the country A that is the same country in which the data center DC01 is arranged. Then, the migration control unit 53 migrates the virtual machine (VM) in which the failure has occurred to the data center DC04 ((2) illustrated in FIG. 12). Then, in the data center DC04 to which the virtual machine in which the failure has occurred is migrated, the engineer belonging to the DC04 is assigned to handle the subject failure ((3) illustrated in FIG. 12). Consequently, the failure monitoring device 14 can perform the migration by giving a priority to the data center that is arranged in the same country and, consequently, the failure monitoring device 14 can promptly handle the failure in the system.

Furthermore, the components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, each of the processing units, such as the detecting unit 50, the extracting unit 51, the selecting unit 52, and the migration control unit 53, may also be integrated as a single unit. Furthermore, the processes performed by the processing units may also be appropriately separated into processes performed a plurality of processing units. Furthermore, all or any part of the processing functions performed by each device can be implemented by a CPU and by programs analyzed and executed by the CPU or implemented as hardware by wired logic.

Failure Monitoring Program

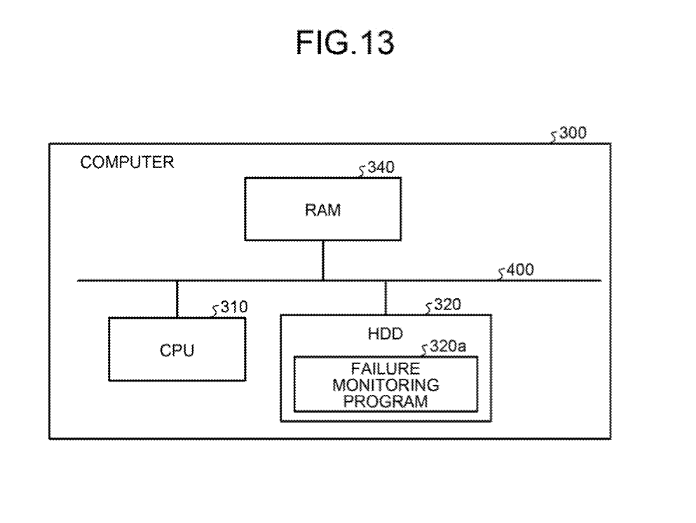

Furthermore, various kinds of processes described in the above embodiments can be implemented by executing programs prepared in advance for a computer such as a personal computer or a workstation. Accordingly, in the following, a description will be given of an example of a computer system that executes a program having the same function as that performed in the embodiment described. FIG. 13 is a block diagram illustrating the computer that executes a failure monitoring program.

As illustrated in FIG. 13, a computer 300 includes a central processing unit (CPU) 310, a hard disk drive (HDD) 320, and a random access memory (RAM) 340. Each of the units 310 to 340 are connected via a bus 400.

The HDD 320 stores therein, in advance, a failure monitoring program 320a having the same function as that performed by the detecting unit 50, the extracting unit 51, the selecting unit 52, and the migration control unit 53 described above. The failure monitoring program 320a may also appropriately be separated.

Furthermore, the HDD 320 stores therein various kinds of information. For example, the HDD 320 stores therein various kinds of data that are used for the OS or production planning.

Then, the CPU 310 reads the failure monitoring program 320a from the HDD 320 and executes the program so that the failure monitoring program 320a executes the same operation as that executed by each of the processing units described in the embodiments. Namely, the failure monitoring program 320a executes the same operation as that performed by the detecting unit 50, the extracting unit 51, the selecting unit 52, and the migration control unit 53.

Furthermore, the failure monitoring program 320a described above is not always needed to be initially stored in the HDD 320.

For example, the program is stored in a “portable physical medium”, such as a flexible disk (FD), a CD-ROM, a DVD disk, a magneto-optic disk, an IC CARD, or the like, that is to be inserted into the computer 300. Then, the computer 300 may read and execute the program from the portable physical medium.

Furthermore, the program may also be stored in “another computer (or a server)” connected to the computer 300 via a public circuit, the Internet, a LAN, a WAN, or the like. Then, the computer 300 may also read and execute the program from the other computer.

According to an aspect of an embodiment of the present invention, it is possible to speed up handling of a failure in a system in a data center in a region that is not able to be handled by an engineer.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A failure monitoring device comprising:
a selecting unit that selects, when a failure related to software occurs in a system that is operated in one of data centers that are arranged in geographically separate locations and that can communicate with each other, an engineer who handles the failure; and
a migration control unit that migrates, when an engineer belonging to another data center that is different from the data center in which the system is operated is selected by the selecting unit, the system to the another data center.

2. The failure monitoring device according to claim 1, wherein the selecting unit selects the engineer belonging to the data center in which the system is operated by giving a higher priority to the engineer belonging to the data center in which the system is operated than to engineers belonging to the another data center.

3. The failure monitoring device according to claim 1, further comprising:
a storing unit that stores therein information about skills of engineers belonging to the data centers; and
an extracting unit that extracts, on the basis of the skills of the engineers stored in the storing unit, engineers who can handle the failure, wherein
the selecting unit selects, from the engineers extracted by the extracting unit, the engineer who handles the failure.

4. The failure monitoring device according to claim 3, wherein the extracting unit extracts, on the basis of an action time that is time at which the engineers stored in the storing unit can handle the failure and time at which the failure occurred, an engineer whose action time is included in the time at which the failure occurred.

5. A non-transitory computer-readable recording medium having stored therein a failure monitoring program that causes a computer to execute a process comprising:
selecting, when a failure related to software occurs in a system that is operated in one of data centers that are arranged in geographically separate locations and that can communicate with each other, an engineer who handles the failure; and
migrating, when an engineer belonging to another data center that is different from the data center in which the system is operated is selected, the system to the another data center.

6. The computer-readable recording medium according to claim 5, wherein the selecting selects the engineer belonging to the data center in which the system is operated by giving a higher priority to the engineer belonging to the data center in which the system is operated than to engineers belonging to the another data center.

7. The computer-readable recording medium according to claim 5, further comprising:
storing, in a storing unit, information about skills of engineers belonging to the data centers; and
extracting, on the basis of the skills of the engineers stored in the storing unit, engineers who can handle the failure, wherein
the selecting selects, from the engineers extracted in the extracting, the engineer who handles the failure.

8. The computer-readable recording medium according to claim 7, wherein the extracting extracts, on the basis of an action time that is time at which the engineers stored in the storing unit can handle the failure and time at which the failure occurred, an engineer whose action time is included in the time at which the failure occurred.

9. A failure monitoring method comprising:
selecting, performed by a computer when a failure related to software occurs in a system that is operated in one of data centers that are arranged in geographically separate locations and that can communicate with each other, an engineer who handles the failure; and
migrating, performed by the computer when an engineer belonging to another data center that is different from the data center in which the system is operated is selected, the system to the another data center.

10. The failure monitoring method according to claim 9, wherein the selecting selects the engineer belonging to the data center in which the system is operated by giving a higher priority to the engineer belonging to the data center in which the system is operated than to engineers belonging to the another data center.

11. The failure monitoring method according to claim 9, further comprising:
storing, in a storing unit, information about skills of engineers belonging to the data centers; and
extracting, performed by the computer, on the basis of the skills of the engineers stored in the storing unit, engineers who can handle the failure, wherein
the selecting selects, from the engineers extracted in the extracting, the engineer who handles the failure.

12. The failure monitoring method according to claim 11, wherein the extracting extracts, on the basis of an action time that is time at which the engineers stored in the storing unit can handle the failure and time at which the failure occurred, an engineer whose action time is included in the time at which the failure occurred.
